(19) United States
(12) Patent Application Publication
(10) Pub. No.: US 2018/0330332 A1
(43) Pub. Date: Nov. 15, 2018

(54) CENTRALIZED TIME ENTRY PLATFORM

(71) Applicant: MRP LLC, Austin, TX (US)

(72) Inventor: Mitesh PATEL, Austin, TX (US)

(73) Assignee: MRP LLC, Austin, TX (US)

(21) Appl. No.: 15/593,604

(22) Filed: May 12, 2017

(51) Int. Cl. G06Q 10/10

(52) U.S. Cl. CPC G06Q 10/1091; G06Q 10/1097

(57) ABSTRACT

A method and system for centralized time entry. Such a system may function to synchronize and consolidate tasks across various applications, such as Personal Information Management (PIM) software and Project Portfolio Manager (PPM) software, into one centralized system. Such a system may further allow employees and consultants to seamlessly account for tasks, such as calendar items stored in PIM software, and may allow time reporting information to be exported and consolidated quickly and efficiently. On the management side, such a system may allow timesheet approval to be performed within the system and may further provide a resource allocation visualizer, allowing resource allocation anomalies identified in timesheets to be quickly identified and addressed.

### BACKGROUND

It has historically been difficult for businesses to integrate all of the different forms of time-tracking and scheduling software that they may use. For example, a given business might make use of project and portfolio management software (such as CA PPM/CA CLARITY PPM) to manage the projects being worked on by its employees, may make use of smartsheet software or other tools for projects following AGILE methodology, may make use of separate vendor management tools (such as FIELDGLASS) to manage consultants or procure staffing services, and may finally make use of still different software (such as MICROSOFT OUTLOOK or another personal information manager) for tracking meetings and vacation days. Some businesses—such as, for example, larger or less coordinated businesses—might even use different tools to perform the same functions in different departments or in different locations. For example, a business might use CA CLARITY PPM in most cases, but a particular department or even a particular project team may prefer the PPM features of MICROSOFT SHAREPOINT and use that instead.

It is generally extremely cumbersome, for management, consultants, and employees alike, to simultaneously make use of all of these different software tools. Any of these users may find it obnoxious to have to log time in one system after another, and to have to decipher which system to log time to (and in conjunction with which project) depending on which system they were in. Consultants, in particular, may find that they are entering time into too many applications, if they are expected to work with different parts of the business or if they are expected to use a vendor management system (VMS). Further, accounting and invoicing at the end of each month generally must be done manually and can consume a significant amount of time.

The end result of the use of all of these different software tools is typically that each of the software tools will end up telling a different story. Even in cases where employees or consultants are intended to be billing to the same projects and programs (using multiple different systems), these systems will tend to diverge from one another, so that no one system has the same information as the rest.

The lack of integration between each software tool also reduces the value of any one software tool for project planning. For example, if a particular company makes use of one tool (such as MICROSOFT OUTLOOK or another personal information manager) for planning meetings and tracking vacations, and makes use of other PPM software to track availability, the inability to synchronize the two may lead to resource allocation anomalies. If an employee is on vacation or obligated to attend large numbers of meetings during a particular time period, this may not be reflected in allocation planning, and the business may find itself short-staffed during the time period.

### SUMMARY

A system and method for centralized time entry may be shown and described. Such a system may function to synchronize and consolidate tasks across various applications into one centralized system. Such a system may further allow employees and consultants to seamlessly account for tasks, such as, for example, MICROSOFT OUTLOOK calendar items. Such a system may further allow resource allocation anomalies identified in timesheets to be quickly identified and addressed. Such a system may further allow time reporting information to be exported and consolidated quickly and efficiently. Advantageously, such a system may allow a computer to perform a greater degree of the time recording and reporting process, improving efficiency and allowing efficiency to continue to improve as hardware performance improves.

In an exemplary embodiment, a method for centralized time entry may include the steps of: retrieving, on a centralized time entry platform, from a personal information management tool, PIM calendar and task information for a user; retrieving, on the centralized time entry platform, from a project portfolio manager, PPM task information for the user; generating, with a processor, on a graphical user interface, an enhanced time entry record integrating the PIM calendar and task information and the PPM task information; updating and recording the enhanced time entry record (such as in response to user input); selecting, with the centralized time entry platform, updated PIM data from the enhanced time entry record, communicating the updated PIM data to the personal information management tool, and reconciling the updated PIM data with the PIM calendar and task information of the user stored on the personal information management tool; and selecting, with the centralized time entry platform, updated PPM data from the enhanced time entry record, communicating the updated PPM data to the project portfolio manager, and reconciling the updated PPM data with the PPM task information of the user stored on the project portfolio manager.

In an exemplary embodiment, the centralized time entry platform may be configured to communicate with each of the personal information management tool and the project portfolio manager by an open API. Such embodiments may be able to make use of recent developments in open APIs for such programs and the general maturation of the field of technology, permitting the integration of personal information management tools and project portfolio managers with other applications.

In an exemplary embodiment, the centralized time entry platform may be integrated with the PIM tool, and may be, for example, installed as an add-on. Some exemplary personal information management tools may support modification or add-on functionality, motivated by, for example, consolidations of software intended for personal information management into more comprehensive personal information management tools creating a demand for core base integration offerings for those comprehensive personal information management tools. However, it should be noted that, in some exemplary embodiments, it may be possible or desirable to use unconsolidated software intended for personal information management (such as, for example, previous versions of personal information management software designed to work on legacy systems, or more specialized personal information management software) and such software may be used instead of or in combination with a PIM tool.

In an exemplary embodiment, the centralized time entry platform may be configured to periodically prepare, from the enhanced time entry record, a single file record of the enhanced time entry record data, and automatically disseminate, to at least one predetermined recipient, the single file record of the enhanced time entry record data. In an exemplary embodiment, the period in which this file record is sent may be, for example, every week, or every two weeks, or every month.

In an exemplary embodiment, the method may further include retrieving, on a second instance of a centralized time entry platform (which may be the first instance of the centralized time entry platform with a different user logged in, if desired), the enhanced time entry record, and associating the enhanced time entry record with the user; displaying, on a graphical user interface, the enhanced time entry record; altering an approval state of the enhanced time entry record, the step of altering the approval state of the enhanced time entry record including at least one of approving the enhanced time entry record of the user or denying the enhanced time entry record of the user; and communicating the altered approval state of the enhanced time entry record to the project portfolio manager.

In an exemplary embodiment, the method may further include retrieving, on a second instance of a centralized time entry platform, from the personal information management tool and the project portfolio manager, updated PIM data and updated PPM data for at least one resource; generating, on the second instance of the centralized time entry platform, an allocation plan, the allocation plan including a comparison of the updated PIM data and updated PPM data for the at least one resource with the intended allocation of the at least one resource; displaying, on a graphical user interface, the allocation plan; updating and recording the allocation plan in response to user input; and selecting, with the second instance of the centralized time entry platform, allocation plan PPM data from the allocation plan, communicating the allocation plan PPM data to the project portfolio manager, and reconciling the allocation PPM data with the PPM task information of the at least one resource stored on the project portfolio manager.

In an exemplary embodiment, an allocation plan may be displayed on the graphical user interface as a plurality of cells, each of the cells corresponding to a resource and a time period, each of the cells storing an allocation score for the resource in the time period, wherein each of the cells is provided in a first color if the allocation score is below a first threshold value, wherein each of the cells is provided in a second color if the allocation score is between a first threshold value and a second threshold value, and wherein each of the cells is provided in a third color if the allocation score is above a second threshold value.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary flowchart depicting an exemplary embodiment of a system for centralized time entry.

FIG. 2 is an exemplary embodiment of an interface for a centralized time entry platform.

FIG. 3A is an exemplary embodiment of a main interface of a centralized time entry platform.

FIG. 3B is an exemplary embodiment of a project and task name assistant tool of a centralized time entry platform.

FIG. 4A is an exemplary embodiment of a time sheet approval interface.

FIG. 4B is an exemplary embodiment of a details popup screen.

FIG. 4C is an exemplary embodiment of a message popup screen.

FIG. 5 is an exemplary embodiment of a timesheet status and history interface.

FIG. 6 is an exemplary embodiment of a resource allocation planning interface.

FIG. 7 is an exemplary embodiment of an exported data set.

FIG. 8 is an exemplary flowchart depicting an exemplary embodiment of a method of using a centralized time entry platform.

FIG. 9A is an exemplary embodiment of a section of a main interface of a centralized time entry platform featuring a “vacation” tab.

FIG. 9B is an exemplary embodiment of an employee-focused “vacation request” dialog.

FIG. 9C is an exemplary embodiment of a management-focused “vacation approval” dialog.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of a centralized task entry platform may be disclosed.

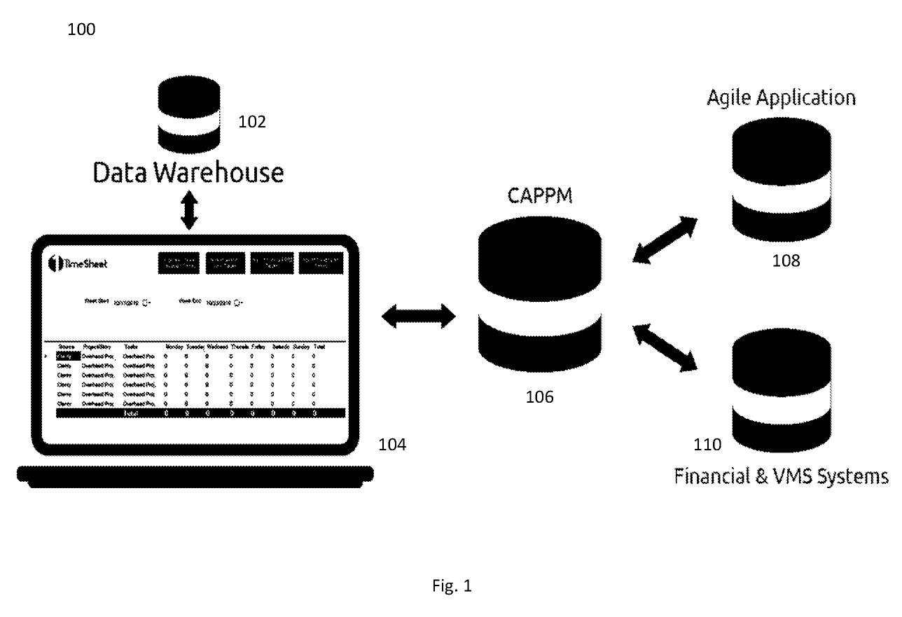

Turning now to exemplary FIG. 1, FIG. 1 displays an exemplary flowchart depicting a system for centralized time entry 100. In an exemplary embodiment, a centralized time entry platform 104 may communicate with a data warehouse 102 and a PPM system 106, such as a CA PPM system, which may in turn communicate with other applications 108, 110. Alternatively, according to an exemplary embodiment, a centralized time entry platform 104 may communicate directly with one or more of the other applications 108, 110 in addition to the PPM system 106, or instead of the PPM system 106. In an exemplary embodiment, communications via the centralized time entry platform 104 and the PPM system 106 may make use of an open API.

In an exemplary embodiment, a PPM system 106 may instead be, for example, a project management (PM) system, an enterprise project management (EPM) system, an enterprise resource planning (ERP) system, or may be any other similar type of program, as may be desired.

According to an exemplary embodiment, a centralized time entry platform 104 may be based off of another platform and may be created by, for example, installing an add-on on said other platform. For example, according to an exemplary embodiment, a centralized time entry platform 104 may be designed to function with MICROSOFT OUTLOOK or a similar personal information manager program, and may function as an add-on for MICROSOFT OUTLOOK or the similar program (“MICROSOFT OUTLOOK or similar programs” may hereinafter be referred to as “personal information management (PIM) tools”). In another exemplary embodiment, a centralized time entry platform 104 may be a stand-alone platform, if desired.

According to an exemplary embodiment, a centralized time entry platform 104 may operate to consolidate timesheet data in one location through a PIM tool, and may further operate to automatically disseminate the time information to the appropriate target source systems. The centralized time entry platform 104 may sync data from the PIM tool, such as the calendar time of the application, to the PPM system 106.

According to an exemplary embodiment, a centralized time entry platform 104 may be configured to, on a monthly basis, collect vendor time data in a single file and deliver the single file to management. This submission may be, for example, through an email sent from the PIM tool, or through another delivery method, as desired. According to another exemplary embodiment, the centralized time entry platform 104 may operate on any other timescale, and may, for example, send weekly or biweekly vendor time data reports instead of monthly reports to management.

In another exemplary embodiment, vendor time data may be sorted into multiple files, which may be organized according to any criteria. For example, according to an exemplary embodiment, a manager may be sent multiple files by a centralized time entry platform, each of which corresponds to vendor time data associated with a particular project or set of projects. In an embodiment, this may be customizable by the manager. For example, according to an exemplary embodiment, a manager may wish to see all vendor time data associated with a first project (“Project A”) in a first file, and may wish to see all other vendor time data associated with all other projects or other activities in a second file; the manager may be able to customize the reporting of the centralized time entry platform so that such information is provided.

According to an exemplary embodiment, a centralized time entry platform 104 may permit a manager or other authorized party, such as a project team lead or project resource manager, to approve timesheets in the centralized time entry platform 104. According to an exemplary embodiment, a centralized time entry platform 104 may be configured to pass approval information to the PPM program 106, or may be configured to pass approval information on to other sources (such as other sources 108, 110).

According to an exemplary embodiment, a centralized time entry platform 104 may facilitate allocation planning for a project team or other group. According to an exemplary embodiment, a centralized time entry platform 104 may combine availability data for one or more members of the group with allocation data representing the tasks that the member of the group has been assigned to perform, improving the reliability of the allocation plans.

According to an exemplary embodiment, various export options may be available for the centralized time entry platform 104. For example, according to an exemplary embodiment wherein the centralized time entry platform 104 is created by incorporating an add-on into another program, such as a PIM tool, all of the export options of the other program may be available. According to another exemplary embodiment, a centralized time entry platform 104 may be able to export data in any file format known in the art or any set of file formats known in the art; for example, according to an exemplary embodiment, a centralized time entry platform 104 may be able to export data in XLSX format and PDF format.

According to some exemplary embodiments, and again referring generally to the Figures, different functionality may be made available for each different category of user of a centralized time entry platform 104. Each different category of user may also perform different steps in order to make use of the platform. For example, timesheet users, timesheet approvers, resource managers, project managers, and consultant user may all have different user experiences with the program or may have different capabilities made available to them.

According to an exemplary embodiment, a timesheet user may be provided with a single user interface in which to enter time. A timesheet user may make use of the program by opening the centralized time entry platform 104 interface, for example through the PIM tool, importing data from a source (such as CA PPM software, or from the PIM tool itself), and then interacting with the displayed timesheet. A user may then perform actions such as entering information into the displayed timesheet, submitting the timesheet, or saving the timesheet.

According to an exemplary embodiment, a timesheet approver may have the option to view and approve any or all timesheet information over which they have authority. The timesheet approver may also have the ability to submit timesheet approval information, through the centralized time entry platform 104, to any source system. A timesheet approver may make use of the program by opening the centralized time entry platform 104 interface, for example through the PIM tool, viewing timesheet data, choosing whether to approve or reject timesheet data, and sending any applicable reminder notifications.

According to an exemplary embodiment, a resource manager may be provided with a simplified tool for resource allocation planning through the centralized time entry platform 104. This may allow a resource manager to perform at least routine resource management activities within the centralized time entry platform 104. A resource manager may make use of the program by opening the centralized time entry platform 104 interface, for example through the PIM tool, opening a list of allocations corresponding to a team over which the resource manager has authority (the “My Team” allocation), viewing a color-coded Over/Under allocation report, and setting the team's allocation. The resource manager may then be able to save this information back to CA PPM.

According to an exemplary embodiment, a project manager may be provided with an interface through which they can view the impact of timesheets on their projects. Such an interface may also allow a project manager to easily prepare consultant invoices for reconciliation purposes. A project manager may make use of the program by opening the centralized time entry platform 104 interface, for example through the PIM tool, viewing the timesheets of one or more project team members, approving the timesheets of one or more project team members, preparing an invoice, and performing invoice reconciliation.

According to an exemplary embodiment, a consultant user may be provided with an interface through which they can enter time and retrieve timesheet details for vendor invoicing. Such details may be prepared in a consolidated form, increasing convenience and helping to ensure that some details are not left out. A consultant user may make use of the program by opening the centralized time entry platform 104 interface, for example through the PIM tool, importing data from one or more sources (for example, CA PPM or a PIM tool), entering data into a timesheet, submitting the timesheet, and then directing the centralized time entry platform 104 to package all timesheets into a single PDF and email the PDF to a vendor management company. Other settings or options may also be available; for example, it may be desired to package all timesheets in a different form prior to sending, and a consultant user may be able to enable this setting.

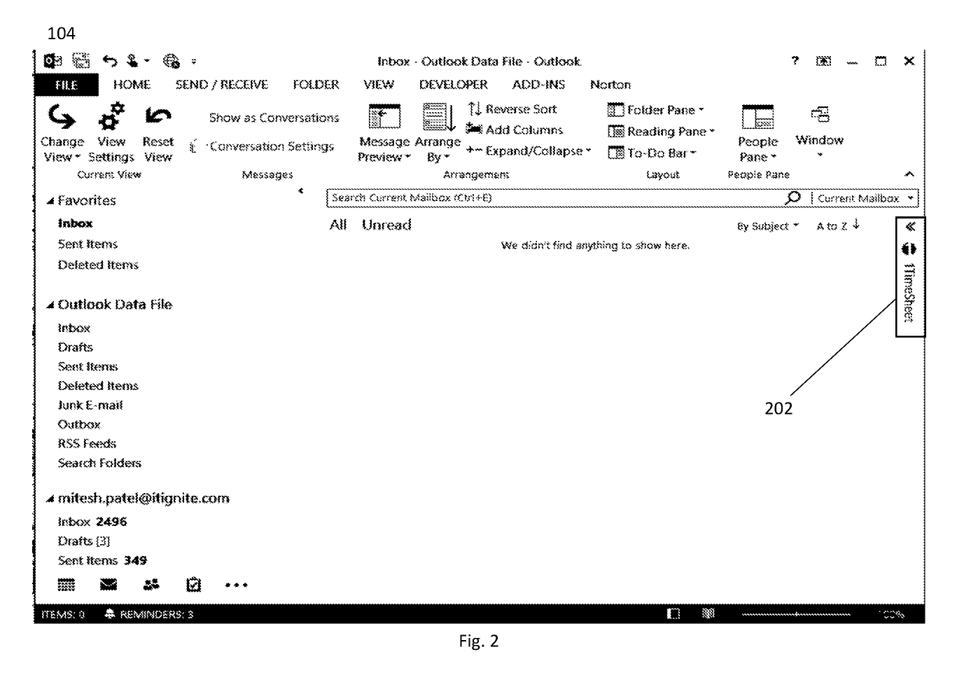

Turning now to exemplary FIG. 2, FIG. 2 shows an exemplary embodiment of an interface for a centralized time entry platform 104, created by incorporating an add-on program into the PIM tool. In an exemplary embodiment, the PIM program may display, on a main interface, an option to access the features that exist as part of the add-on program 202.

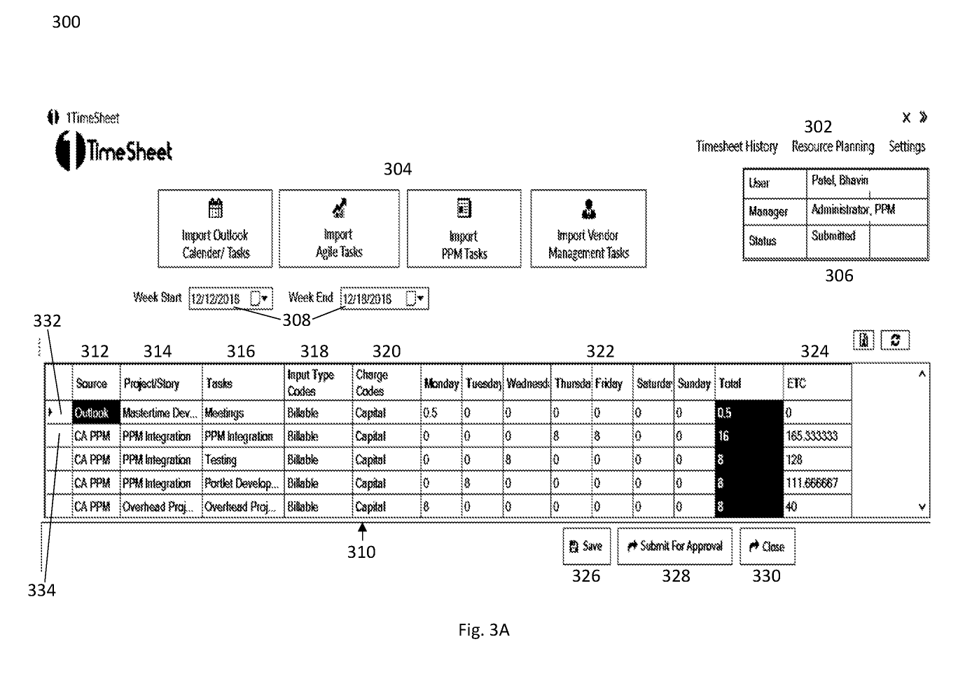

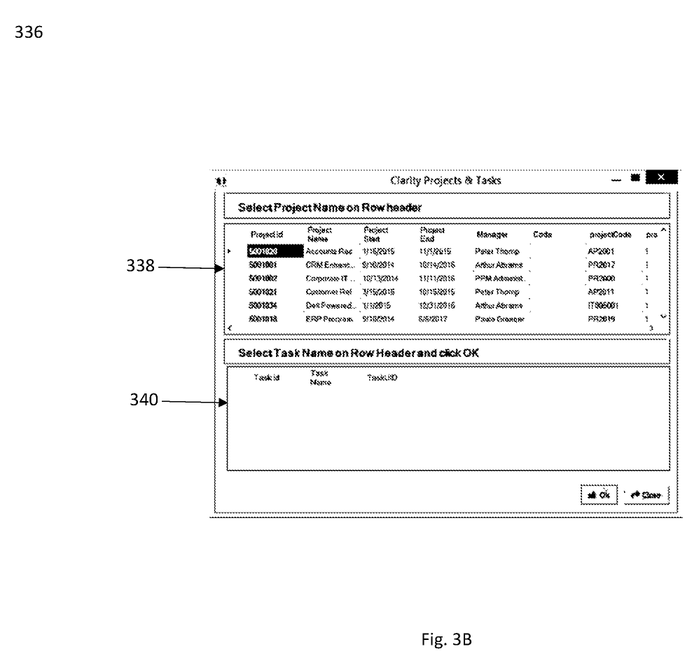

Turning now to exemplary FIG. 3A, FIG. 3A shows an exemplary embodiment of a main interface 300 of a centralized time entry platform 104. According to an exemplary embodiment, such an interface 300 may include a settings menu 302, an options menu 304, and a user account information display 306. In an exemplary embodiment, such information may be displayed at the top portion of the interface; in another exemplary embodiment, such information may be displayed anywhere on the interface. Such an interface 300 may further display a time selector 308 (which may be, for example, an option to select a start date and an end date) and may display information for that time period in a timesheet table 310.

According to an exemplary embodiment, a user may, through the settings menu 302, be able to access options such as “timesheet history,” “resource planning,” and general program settings. In an exemplary embodiment, a user selection of the “timesheet history” option may provide a series of options relevant to viewing timesheet history, such as allowing the user to view a dedicated timesheet history page. A user selection of the “resource planning” option may provide a series of options relevant to performing resource planning, such as allowing the user to view a dedicated resource planning page. A user selection of the “settings” option may provide a number of program settings options that the user can change, or may bring up a dedicated settings page.

According to an exemplary embodiment, a user may be provided with the options, on the options menu 304, to import data from one of several sources. For example, according to an exemplary embodiment, a user may be provided with the option to import calendars and/or tasks from common time tracking software, such as the PIM tool, an Agile program, a PPM program, or a vendor management system (VMS). Example programs from which a user may import data may include CA CLARITY PPM, MICROSOFT OUTLOOK, JIRA, FIELDGLASS, and VERSIONONE. In an embodiment, selecting one of these options may open up a dialog in which a user can select which calendars or tasks to import from the program.

In an exemplary embodiment, the options of the options menu 304 may be fixed. In some embodiments, the options of the options menu 304 may be customized in order to support the needs of a specific client, so that, for example, a PPM system operated by a client, an email program operated by a client, and a VMS program operated by a client are all directly associated with the options menu 304. In another exemplary embodiment, the options of the options menu 304 may be automatically created based on what programs are detected. In some exemplary embodiments, data may be exported back into the programs of the options menu 304, or otherwise tied back into the programs of the options menu 304, for example in order to increase precision with regard to resource labor expenditure.

According to an exemplary embodiment, the options menu 304 options may be specifically linked to particular programs, such that the selection of, for example, the option to import a calendar or task list from the PIM tool is associated with a specific MICROSOFT OUTLOOK installation or an installation of a similar program (such as a MOZILLA THUNDERBIRD installation). In such an embodiment, the selection of the options menu 304 option may open up a dialog in which a user can select which calendars or tasks to import from that program. In another exemplary embodiment, the selection of the options menu 304 option may provide a user with a dialog in which they can import files of a file type associated with a calendar or a task list of a particular program (such as a “personal folder” file or .pst file from MICROSOFT OUTLOOK).

According to an exemplary embodiment, a user account information display 306 may be provided, which may display certain information about the user account that is currently accessing the main interface 300 of the centralized time entry platform 104. For example, according to an exemplary embodiment, the user “Patel, Mitesh” may be signed in to the program, and may be displayed as the “user” of the program. The user account information display 306 may further display certain information associated with the user account of the logged-in user, “Patel, Mitesh,” such as, for example, who the manager of the user is (in this case, the manager of the user is saved as the “PPM Administrator”), and whether or not the user has submitted a timesheet for the active time selection.

According to an exemplary embodiment, a user may be provided with an option to select the active time period, which may be accomplished through, for example, the use of a time selector 308. For example, according to an exemplary embodiment, this time selector 308 may be a set of drop-down menus in which a user can select a start date and/or an end date of timesheet data to be displayed. In an embodiment, a user may be permitted to select only those times corresponding to one timesheet, which may be, for example, a weekly timesheet; in such an embodiment, a user may have the option to select start dates defined as a first day of the week (such as a Monday) and the end date will be automatically set to the corresponding last day of the week (such as a Sunday). In another exemplary embodiment, a user may be able to select a custom date range, such as a date range that spans multiple weeks or splits a week.

According to an exemplary embodiment, a timesheet table 310 may be provided for the user for the selected time period 308. According to an exemplary embodiment, a timesheet table 310 may include a number of columns, including a data source column 312, a project column 314, a task column 316, an input type code column 318, a charge code column 320, a number of columns corresponding to particular days of the week 322, and an Estimate to Complete (ETC) column 324. In some exemplary embodiments, one or more of these columns may be absent, and/or one or more additional columns may be present.

According to an exemplary embodiment, each row in the timesheet table 310 may correspond to a particular entry in the timesheet. For example, according to an exemplary embodiment, a first row 332 in the timesheet table 310 may correspond to a meeting for a particular project that took 0.5 hours on Monday. The next row 334 in the timesheet table 310 may correspond to activity on the PPM Integration project that took place for 8 hours on Thursday and 8 hours on Friday. Subsequent rows may correspond to similar entries.

According to an exemplary embodiment, a data source column 312 may include, for example, an indication of which program provided the data. For example, according to an exemplary embodiment, data on a first entry 332 (specifically a meeting for the Mastertime development project), shown in a top row of the timesheet table 310, may have been provided by the PIM tool. Data on a second entry 334, shown in the next row of the timesheet table 310, may have been provided by CA PPM.

According to an exemplary embodiment, a project column 314 may include, for example, an indication of which project for which a particular activity was performed. (This may alternatively be referred to as a “story” for Agile projects.) For example, according to an exemplary embodiment, a project may be the “PPM Integration Project.”

According to an exemplary embodiment, a tasks column 316 may include, for example, an indication of the nature of the task that was performed for a particular project. For example, according to an exemplary embodiment, a user may spend 0.5 hours performing the “meetings” task (i.e. attending a meeting) for the “Mastertime development” project 332, and may spend 16 hours performing the “PPM Integration” task for the “PPM Integration” project 334.

In an exemplary embodiment, an “input type code” column 318 may display an indication of whether or not the task completed by a user for a particular project is billable to the project. In the timesheet table 310 shown in FIG. 3A, all of the tasks are shown as billable.

In an exemplary embodiment, a “charge code” column 320 may display an indication of what account billable time should be charged to. In the timesheet table 310 shown in FIG. 3A, all of the tasks are billable to the “Capital” account.

In an exemplary embodiment, a set of “days of the week” columns 322 may provide an indication of when tasks were performed. In an embodiment, a user may enter, on each day of the week wherein they worked on a task, a number of hours that the user worked on the task, provided that the number of hours they worked on the task is greater than zero. For example, in a first row 332, a user may have worked on the task (attended the meeting) for 0.5 hours on Monday, and as such may enter “0.5” for Monday. Such information may also be imported from other programs, such as, for example, a PIM tool for meeting information.

In an exemplary embodiment, an “ETC” column 324 may be provided, in which an estimated time to completion for a particular project or particular task may be provided. For example, according to an exemplary embodiment, for the project task in the second row 334, a user may have worked 16 hours over the course of the week, and the project task may thus have an ETC estimate of 165.333 hours associated with it.

According to an exemplary embodiment, a user may be provided with the option to save 326 the timesheet table 310, may be provided with the option to directly submit 328 the timesheet table 310 for approval, any may be provided with the option to close the timesheet table 310. Other options may also be made available to the user, as desired.

Turning now to exemplary FIG. 3B, FIG. 3B displays an exemplary embodiment of a project and task name assistant tool 336 that a user may be able to cause the main interface 300 of the centralized time entry platform 104 to display. For example, according to an exemplary embodiment, a user may select an entry in either the project column 314 or the task column 316, which may cause a project and task name assistant tool 336 to launch.

Such a tool 336 may include a project name selection assistant 338, which may show a list of all project IDs and a selection of project IDs, along with accompanying information about the project such as the project name, the project start date, the projected project end date, the project manager, any applicable codes (such as a project code), and any other information. Alternatively, a project name selection assistant 338 may include only a selection of project IDs.

Such a tool may also include a task name selection assistant 340. According to an exemplary embodiment, a task name selection assistant 340 may show a list of tasks that have been previously entered for a project, by task ID, task name, and task UID (i.e. the user id of the user who entered the task). This may allow a user to select a previously-entered task, allowing a user to incorporate this information into a new timesheet entry.

After selecting one or both of a project name and task name, a user may then be able to select to add the project name and the task name to the timesheet table 310, for example by selecting “OK.” A user may then be able to close the project and task name assistant tool 336.

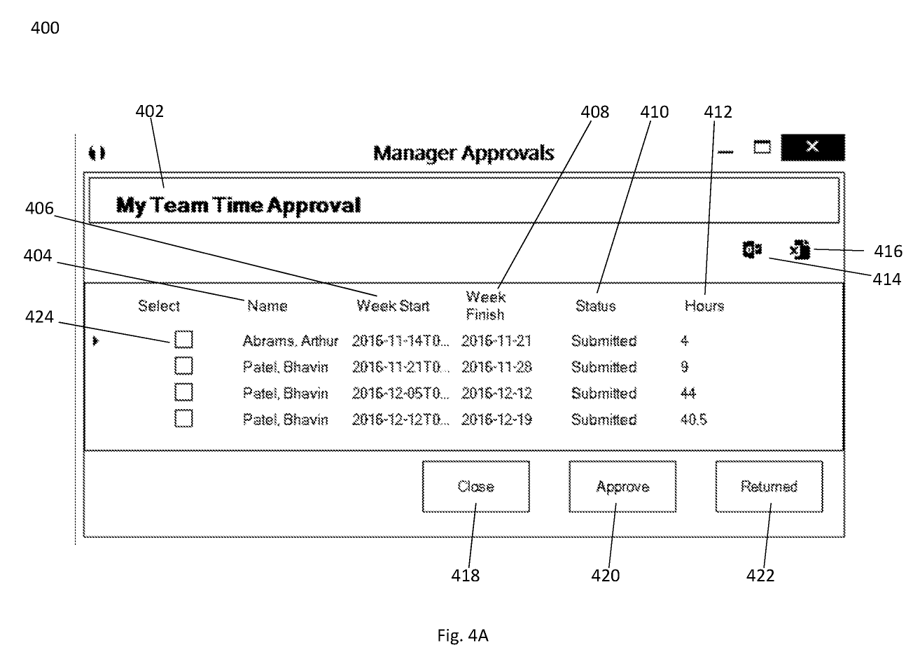

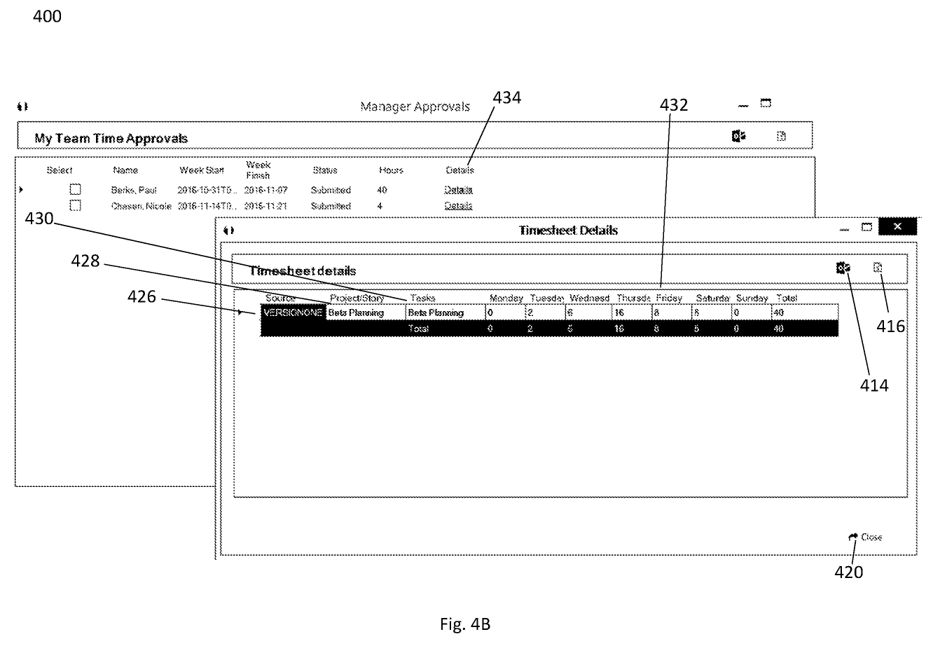

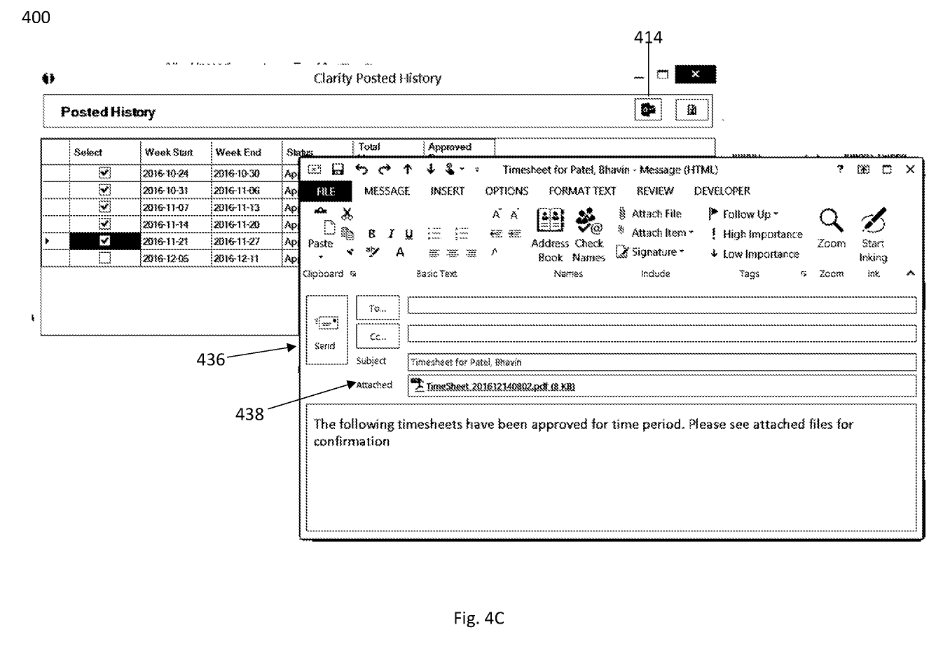

Turning now to exemplary FIG. 4A, FIG. 4A displays an exemplary embodiment of a time sheet approval interface 400. Such an interface may allow timesheet approval to be completed from within a PIM program and may eliminate the need to venture into a PPM program and conduct approvals for specific resources.

According to an exemplary embodiment, a time sheet approval interface 400 may display one or more teams 402 for which a time sheet approver has time sheet approval authority. The interface 400 may then further provide a list of timesheets for the members of the one or more teams. Timesheets may be organized by, for example, the names of the members of the one or more teams 404, the start date of the timesheet 406 (which may be, for example, a weekly timesheet), the end date of the timesheet 408, the status of the timesheet 410, and the number of hours logged in the timesheet 412. A user may also be able to see further details about the timesheet, for example by clicking or otherwise selecting a particular row, or by selecting a “details” dialog provided elsewhere.

According to an exemplary embodiment, a user may be provided with an options menu, which may include one or more options that a user can perform from the interface 400. For example, according to an exemplary embodiment, a user may select an option to send a message from the program 414 using a PIM tool, or may select an option to delete one or more of the entries 416. Other options may also be provided, as desired.

According to an exemplary embodiment, a user may be provided with options to close the program 418, to approve a particular timesheet 420, and to return a particular timesheet to a team member 422. A user may have the option to provide comments through the interface when returning a timesheet. In an exemplary embodiment, a user may select one or more of the timesheets, for example by selecting a box 424, before taking any action.

Turning now to exemplary FIG. 4B, FIG. 4B displays an exemplary embodiment of a screen that may be provided if the user selects a details dialog 434. In an exemplary embodiment, a “timesheet details” screen may be provided, which may show, for example, the source information for the entries in a timesheet 426 (in this case VERSIONONE), the project or story information for the timesheet 428, the task information for the timesheet 430, and the hours worked 432.

Turning now to exemplary FIG. 4C, FIG. 4C displays an exemplary embodiment of a screen that may be provided if a user selects an option to send a message from the program 414 using the PIM tool. In an exemplary embodiment, one or more timesheets may be used to generate a timesheet file, which may be attached 438 to an automatically-generated message 436. This message may then be sent to an appropriate address. This may ensure that a user does not have to engage in the tedious task of capturing screenshot after screenshot, improving efficiency for those users who have to submit weekly, bi-weekly, or monthly invoices along with timesheets. Instead, according to an exemplary embodiment, users may simply select a historical display, click to retrieve their approved timesheets, check the periods of interest, and generate an email 436 with a PDF attachment 438, which may then be emailed in conjunction with an invoice.

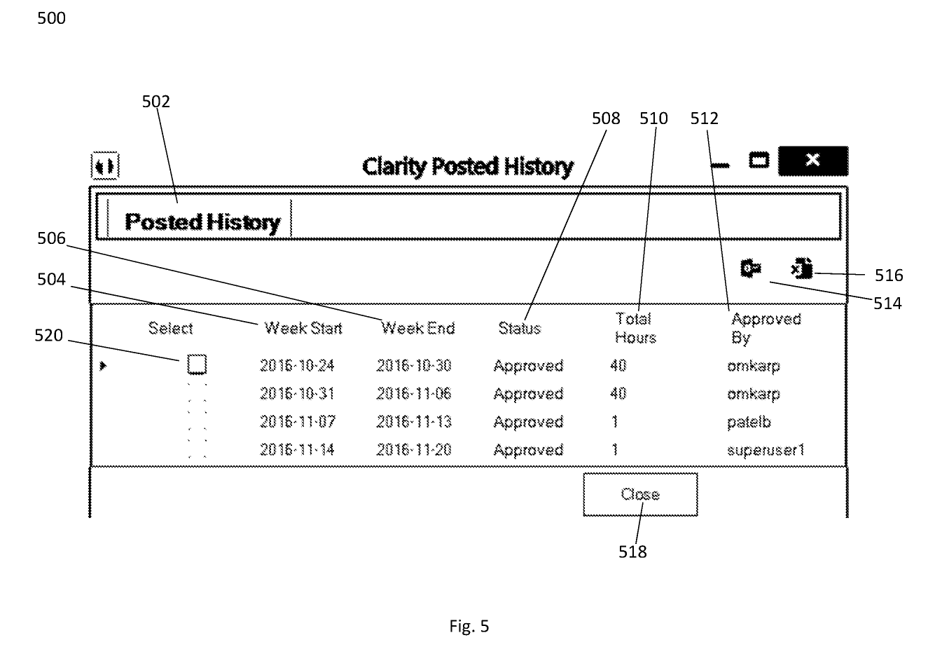

Turning now to exemplary FIG. 5, FIG. 5 displays an exemplary embodiment of a timesheet status and history interface 500. Such an interface 500 may allow historical timesheet data to be easily retrieved from a centralized time entry platform 104, without requiring the user to navigate through any other programs or change interfaces. In an embodiment, a timesheet status and history interface 500 may be available from the main interface of a centralized time entry platform 104; for example, according to an exemplary embodiment, a user may be able to bring up a timesheet status and history interface 500 by selecting a button on the main interface of the centralized time entry platform 104.

According to an exemplary embodiment, a timesheet status and history interface 500 may be available to, or for, a specific user, and may be used to display that user's posted history 502. According to an exemplary embodiment, timesheets may be sorted by the start date of the timesheet 504, the end date of the timesheet 506, the status of the timesheet 508, the total hours logged on the timesheet 510, or the party who approved the timesheet 512. Timesheets in the posted history 502 may also be selected, using, for example, a selection box 520, and one or more actions may be performed on the timesheet. For example, a user may select to send the timesheet in a message from the program 514 using a PIM tool, or may select to delete the timesheet record 516. A user may also have an option to close the interface 518.

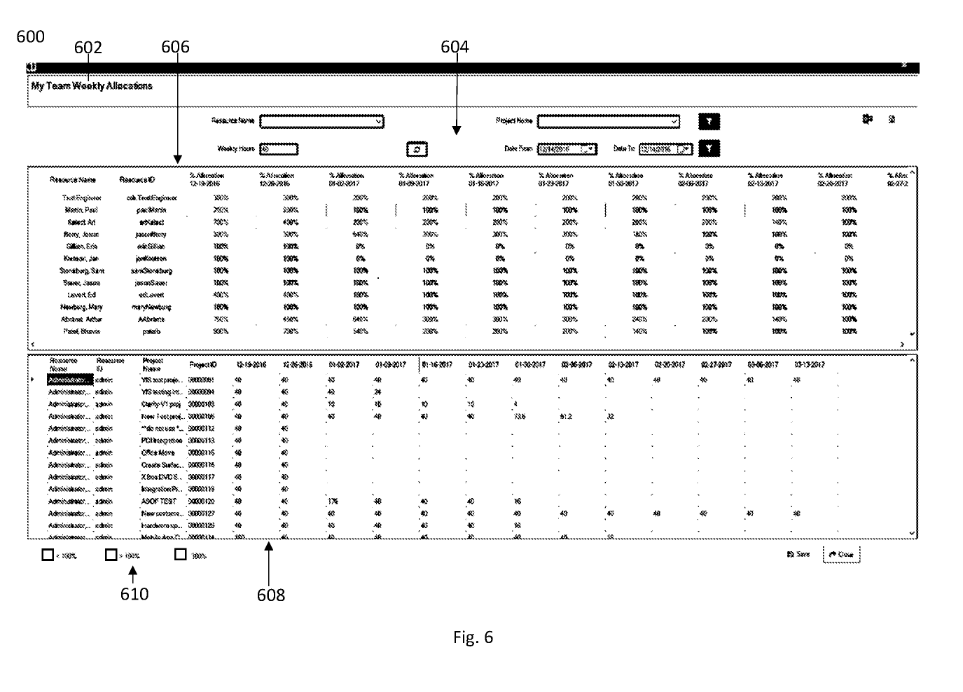

Turning now to exemplary FIG. 6, FIG. 6 displays an exemplary embodiment of an allocation planning interface 600. According to an exemplary embodiment, a resource manager or other similar user may be able to perform resource allocation planning in a centralized time entry platform 104. According to an exemplary embodiment, a centralized time entry platform 104 may provide granular and accurate insight into resource planning for a user of the platform 104.

According to some exemplary embodiments, a resource allocation planning interface 600 may identify the team 602 for which resource allocation planning is to be performed, as well as the term over which resource allocation planning is to be performed. According to an exemplary embodiment, resource planning may be performed for, for example, a week, a month, or any other fixed period of time, or may also be performed for any dynamic period of time, if desired.

According to an exemplary embodiment, an allocation planning interface 600 may include a settings menu 604, in which a user of the allocation planning interface 600 may define one or more settings to be applied to the resource allocation plan generated using the interface 600. For example, according to an exemplary embodiment, a user may be able to select a resource name or a project name, may be able to set a number of hours per week that project team members will be expected to be available (which may have, for example, a default of 40 hours per week), and may be able to define a time period over which resource planning is to be performed.

According to an exemplary embodiment, an allocation planning interface 600 may have a planning view 606. A planning view 606 may display entries for one or more resource names, one or more resource IDs, and one or more allocation percentages associated with a particular date. In an exemplary embodiment, a resource name may be, for example, the name of an employee. Alternatively, if desired, other resources other than human resources could be incorporated into the planning view 606 of an allocation planning interface 600, further facilitating project planning for certain organizations. For example, in one exemplary embodiment, an allocation planning interface 600 may be used to track supercomputer time for a supercomputer intended to have little downtime, and the supercomputer may be assigned as a resource with its own weekly hour score in order to help visualize whether the supercomputer is being fully utilized.

According to an exemplary embodiment, a “resource ID” of a resource may be a system-wide identifier for that particular resource. This may be, for example, an employee username, or an employee ID number, or may be another ID, as desired.

According to an exemplary embodiment, an allocation planning interface 600 may display, in a planning view 606, a set of allocation percentages or other allocation scores for each resource at one or more different dates. This may reflect, for example, the number of hours allocated to each of the employees or other resources on that date or during a time period starting on that date, with the expressed allocation percentage being a relation of how many hours are assigned to a particular resource versus the weekly hours score set in the settings menu. For example, an employee who has been assigned 40 hours of work for a week may be assigned a score of 100%, while an employee who has been assigned 80 hours of work for a week may be assigned a score of 200%. According to an exemplary embodiment, percentages may be displayed in different colors; for example, according to an exemplary embodiment, percentages of (or near) 100% may be displayed in green, percentages lower than 100% may be displayed in red, and percentages higher than 100% may be displayed in yellow. A key may be shown in, for example, the bottom-left corner 610.

According to an exemplary embodiment, an allocation planning interface 600 may display a timesheet view 608, which may show information on the specific number of hours devoted by particular resources to particular projects. For example, according to an exemplary embodiment, a resource named “Administrator” may be shown as having the resource ID “admin,” having devoted 80 hours to the “**do not use**” project name, with a project ID of 00000112. It can be seen that the “Administrator” resource spent 40 hours during the week of 12-19 and 40 hours during the week of 12-26 on this project.

In an exemplary embodiment, the timesheet view 608 may show all timesheets logged by all parties having a resource name; in another exemplary embodiment, the timesheet view 608 may show only timesheet information for a selected resource. For example, according to an exemplary embodiment, a user of the platform 104 may be able to select, through the planning view 606 of the allocation planning interface 600, a particular resource name, which may cause only those timesheet associated with that resource name to be displayed in the timesheet view.

In an embodiment, a centralized time entry platform 104 may import data relevant to resource allocation planning from other programs. Such data may include, for example, scheduled meetings stored in a first program (such as a PIM tool), and timesheet information stored in a second program (such as CA PPM software).

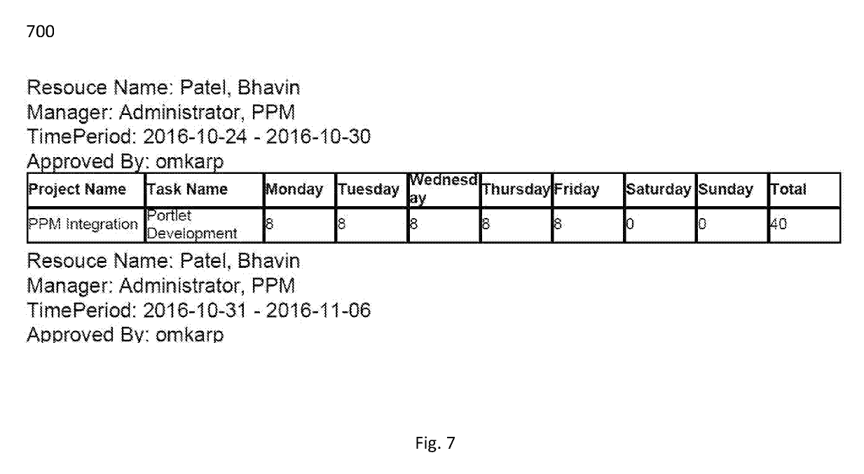

Turning now to exemplary FIG. 7, FIG. 7 displays an exemplary embodiment of an exported data set 700. In an exemplary embodiment, an exported data set 700 may be prepared in spreadsheet form, PDF form, or in any other form, as may be desired. Exporting the data into spreadsheet format may, in some embodiments, allow for more complex analysis, based on what metrics are extracted.

Now referring generally to the figures, according to an exemplary embodiment, a centralized time entry platform 104 may be fully integrated with the security model of a PPM system, or another similar system. Specifically, data extracted from the PPM system or the similar system may pertain directly only to whom it applies. In an exemplary embodiment, resource managers may see only their PPM resources, while resources may see only their PPM projects and their timesheets. This may ensure the integrity of institutional security with regard to the PPM and the centralized time entry platform 104 remains consistent. In an exemplary embodiment, the centralized time entry platform may be configured to fully comply with PPM licensing requirements.

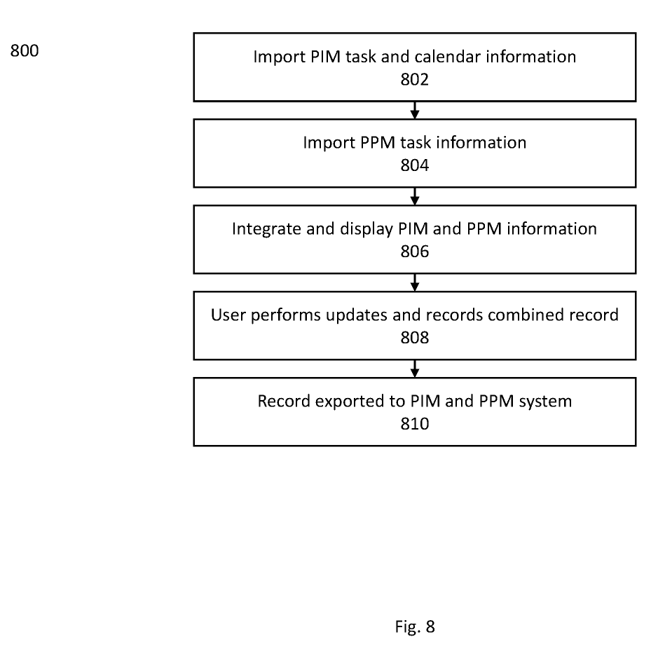

Turning now to exemplary FIG. 8, FIG. 8 displays an exemplary flowchart 800 depicting a method of using a centralized time entry platform 104. According to an exemplary embodiment, a centralized time entry platform 104 may first import information from a PIM system 802, such as task and calendar information. In an embodiment, the centralized time entry platform 104 may be integrated with this PIM system or may be separate, as desired. In a next step, the centralized time entry platform 104 may import information from a PPM system 804, such as task information. Other information may also be imported from these or other systems, as desired.

In a next step, the centralized time entry platform 104 may integrate this information into an enhanced time entry record incorporating data from the PIM system, the PPM system, and any other systems in which the user may have a presence. This information may then be displayed to the user 806.

In a next step, the user may perform any desired modification to the displayed data 808. For example, according to an exemplary embodiment, a user may enter their timesheet information for the week. The user may then record the enhanced time entry record, which may be saved as their timesheet.

In a next step, the information from the enhanced time entry record may be exported to other system than the centralized time entry platform 104. For example, the enhanced time entry record 104 may be exported to the PIM and/or the PPM system in order to provide a more accurate summary of the user's activities and tasks.

In some exemplary embodiments, other features may also be incorporated into or integrated with a centralized time entry platform 104. Referring again to exemplary FIG. 3A, such other features may be made available in, or through an expansion to, the settings menu 302. In other embodiments, other features may be provided elsewhere, as desired.

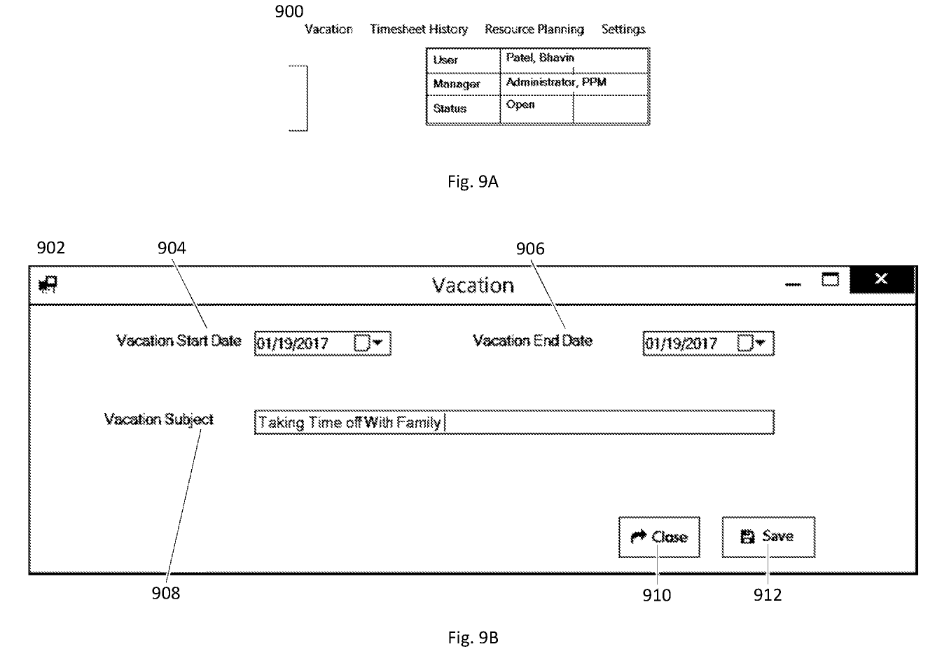

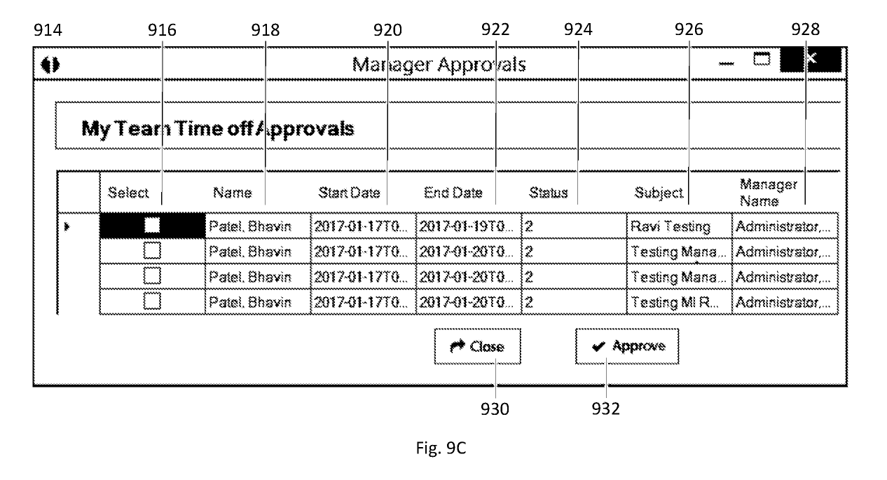

Turning now to exemplary FIG. 9A, it may also be desirable to use a centralized time entry platform 104 for vacation tracking and planning. Such functionality may allow employees to request time off through a formal utility integrated with PIM and/or PPM software, and may allow time off to be approved through a similar utility. Such a utility may be selectable from, for example, a menu bar including a “Vacation” menu option 900, which may be, for example, a link or dropdown menu. In an exemplary embodiment, this menu bar may be a settings menu 302 of a main interface of a centralized time entry platform 300.

Turning now to exemplary FIG. 9B, when a user selects a “Vacation” menu option 900, a “Vacation Request” dialog 902 or similar screen may be displayed. A “Vacation Request” dialog 902 may include an option for a user to select a start date for their vacation request 904, an option for a user to select an end date for their vacation request 906, and an option for a user to select or enter a subject for their vacation request or a reason why they are requesting vacation 908, as well as an option to close the dialog 910 or save and send the request 912.

Turning now to exemplary FIG. 9C, a manager may have a “manager approval” dialog 914 or similar screen available, through which they can approve or deny time off requests for a particular team. For example, according to an exemplary embodiment, a manager may be able to select an employee vacation request 916, view the employee who made the vacation request 918, view the intended start date of the vacation request 920, view the intended end date of the vacation request 922, view the status of the vacation request 924 (such as, for example, the number of days it has been outstanding), view the subject or explanation for the vacation request 926, and view the manager of the employee who made the request 928. A manager may then be able to approve selected vacation requests 932 and close the manager approval dialog 930.

According to an exemplary embodiment, once a request for time off has been approved, the request for time off may be captured in the calendars of one or more programs, such as PIM or PPM software. In an embodiment, the availability of the particular employee may be updated in the PIM or PPM software in order to reflect the approved vacation. The approved vacation may also be displayed in a manager-specific calendar and in a resources calendar, as may be desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for generating a single record reflecting multiple sources of time data, comprising:
retrieving, on a centralized time entry platform, from a personal information management tool, PIM calendar and task information for a user;
retrieving, on the centralized time entry platform, from a project portfolio manager, PPM task information for the user;
generating, with a processor, on a graphical user interface, an enhanced time entry record integrating the PIM calendar and task information and the PPM task information;
updating and recording the enhanced time entry record;
selecting, with the centralized time entry platform, updated PIM data from the enhanced time entry record, communicating the updated PIM data to the personal information management tool, and reconciling the updated PIM data with the PIM calendar and task information of the user stored on the personal information management tool; and
selecting, with the centralized time entry platform, updated PPM data from the enhanced time entry record, communicating the updated PPM data to the project portfolio manager, and reconciling the updated PPM data with the PPM task information of the user stored on the project portfolio manager.

2. The method of claim 1, wherein the centralized time entry platform is configured to communicate with each of the personal information management tool and the project portfolio manager by an open API.

3. The method of claim 1, wherein the centralized time entry platform is integrated with the personal information management tool.

4. The method of claim 1, further comprising:
periodically preparing, on the centralized time entry platform, from the enhanced time entry record, a single file record of the enhanced time entry record data; and
automatically disseminating, to at least one predetermined recipient, the single file record of the enhanced time entry record data.

5. The method of claim 4, wherein the single file record of the enhanced time entry record data is prepared and automatically disseminated at a regular time once per month.

6. The method of claim 1, further comprising:
retrieving, on a second instance of a centralized time entry platform, the enhanced time entry record, and associating the enhanced time entry record with the user;
displaying, on a graphical user interface, the enhanced time entry record;
altering an approval state of the enhanced time entry record, the step of altering the approval state of the enhanced time entry record comprising one of approving the enhanced time entry record of the user or denying the enhanced time entry record of the user; and
communicating the altered approval state of the enhanced time entry record to the project portfolio manager.

7. The method of claim 1, further comprising:
retrieving, on a second instance of a centralized time entry platform, from the personal information management tool and the project portfolio manager, updated PIM data and updated PPM data for at least one resource;
generating, on the second instance of the centralized time entry platform, an allocation plan, the allocation plan comprising a comparison of the updated PIM data and updated PPM data for the at least one resource with the intended allocation of the at least one resource;
displaying, on a graphical user interface, the allocation plan;
updating and recording the allocation plan; and
selecting, with the second instance of the centralized time entry platform, allocation plan PPM data from the allocation plan, communicating the allocation plan PPM data to the project portfolio manager, and reconciling the allocation PPM data with the PPM task information of the at least one resource stored on the project portfolio manager.

8. The method of claim 7, wherein the allocation plan is displayed on the graphical user interface as a plurality of cells, each of the cells corresponding to a resource and a time period, each of the cells storing an allocation score for the resource in the time period; and
wherein each of the cells is provided in a first color if the allocation score is below a first threshold value, wherein each of the cells is provided in a second color if the allocation score is between a first threshold value and a second threshold value, and wherein each of the cells is provided in a third color if the allocation score is above a second threshold value.

9. The method of claim 1, further comprising:
determining an access level of the user, wherein the user has at least one of a resource access level and a resource manager access level; and
controlling access to data of the project portfolio manager accessed through the centralized time entry platform based on the access level of the user;
wherein the user is restricted from retrieving data from the project portfolio manager other than PPM project data of the user and timesheet data of the user when the user has the resource access level; and
wherein the user is permitted to retrieve data of one or more other users when the user has the resource manager access level.

10. A system for performing centralized time entry, comprising:
a personal information management tool;
a project portfolio manager; and
a centralized time entry platform, the centralized time entry platform configured to perform the steps of:
PIM calendar and task information for a user retrieved from the personal information management tool;
PPM task information for the user retrieved from the project portfolio manager;
a processor that generates, on a graphical user interface, an enhanced time entry record integrating the PIM calendar and task information and the PPM task information, and updates and records the enhanced time entry record;
updated PIM data selected from the enhanced time entry record, communicating the updated PIM data to the personal information management tool, and reconciling the updated PIM data with the PIM calendar and task information of the user stored on the personal information management tool; and
updated PPM data selected from the enhanced time entry record, communicating the updated PPM data to the project portfolio manager, and reconciling the updated PPM data with the PPM task information of the user stored on the project portfolio manager.

11. The system of claim 10, wherein the project portfolio manager further comprises a vendor management system.

12. The system of claim 10, wherein the centralized time entry platform is configured to communicate with each of the personal information management tool and the project portfolio manager by an open API.

13. The system of claim 10, wherein the centralized time entry platform is integrated with the personal information management tool.

14. The system of claim 10, wherein the centralized time entry platform further periodically prepares, from the enhanced time entry record, a single file record of the enhanced time entry record data and automatically disseminates, to at least one predetermined recipient, the single file record of the enhanced time entry record data.

15. The system of claim 14, wherein the single file record of the enhanced time entry record data is prepared and automatically disseminated at a regular time once per month.

16. The system of claim 10, wherein the centralized time entry platform is further configured to send, to a second instance of a centralized time entry platform, the enhanced time entry record, the enhanced time entry record being associated with the user; and wherein the second instance of the centralized time entry platform is configured to:
display, on a graphical user interface, the enhanced time entry record;
alter an approval state of the enhanced time entry record, the step of altering the approval state of the enhanced time entry record comprising one of approving the enhanced time entry record of the user or denying the enhanced time entry record of the user; and
communicate the altered approval state of the enhanced time entry record to the project portfolio manager.

17. The system of claim 10, wherein the personal information management tool and the project portfolio manager are configured to perform the step of sending, to a second instance of a centralized time entry platform, updated PIM data and updated PPM data for at least one resource; and wherein the second instance of the centralized time entry platform is configured to:
generate an allocation plan, the allocation plan comprising a comparison of the updated PIM data and updated PPM data for the at least one resource with the intended allocation of the at least one resource;
display, on a graphical user interface, the allocation plan;
update and record the allocation plan; and
select allocation plan PPM data from the allocation plan, communicate the allocation plan PPM data to the project portfolio manager, and reconcile the allocation PPM data with the PPM task information of the at least one resource stored on the project portfolio manager.

18. The system of claim 17, wherein the allocation plan is displayed on the graphical user interface as a plurality of cells, each of the cells corresponding to a resource and a time period, each of the cells storing an allocation score for the resource in the time period; and
wherein each of the cells is provided in a first color if the allocation score is below a first threshold value, wherein each of the cells is provided in a second color if the allocation score is between a first threshold value and a second threshold value, and wherein each of the cells is provided in a third color if the allocation score is above a second threshold value.

19. The method of claim 10, wherein the centralized time entry platform is further configured to:
determine an access level of the user, wherein the user has at least one of a resource access level and a resource manager access level; and
control access to data of the project portfolio manager accessed through the centralized time entry platform based on the access level of the user;
wherein the centralized time entry platform is configured to restrict the user from retrieving data from the project portfolio manager other than PPM project data of the user and timesheet data of the user when the user has the resource access level; and
wherein the centralized time entry platform is configured to permit the user to retrieve data of one or more other users when the user has the resource manager access level.

20. A computer program product embodied on a computer-readable storage medium, the computer program product embodying code that, when executed, causes a processor to perform the steps of:
retrieving, from a personal information management tool, PIM calendar and task information for a user;
retrieving, from a project portfolio manager, PPM task information for the user;
generating, on a graphical user interface, an enhanced time entry record integrating the PIM calendar and task information and the PPM task information;
updating and recording the enhanced time entry record;
selecting updated PIM data from the enhanced time entry record, communicating the updated PIM data to the personal information management tool, and reconciling the updated PIM data with the PIM calendar and task information of the user stored on the personal information management tool; and
selecting updated PPM data from the enhanced time entry record, communicating the updated PPM data to the project portfolio manager, and reconciling the updated PPM data with the PPM task information of the user stored on the project portfolio manager.
